(19) United States
(12) Patent Application Publication
(10) Pub. No.: US 2001/0051597 A1
(43) Pub. Date: Dec. 13, 2001

(54) CLEANING SOLUTION FOR USE IN METAL RESIDUE REMOVAL AND A SEMICONDUCTOR DEVICE MANUFACTURING METHOD FOR EXECUTING CLEANING BY USING THE CLEANING SOLUTION AFTER CMP

(76) Inventors: NOBUHIRO KATO, MIE-KEN (JP); HARUKI NOJO, NEW YORK (JP)

Correspondence Address: FINNEGAN HENDERSON FARABOW, GARRETT & DUNNER, 1300 I STREET N W, WASHINGTON, DC, 200053315

(21) Appl. No.: 09/199,419

(22) Filed: Nov. 25, 1998

(30) Foreign Application Priority Data
Nov. 27, 1997 (JP) P9-326559

(51) Int. Cl. C11D 1/00

(52) U.S. Cl. 510/175

(57) ABSTRACT

There are provided a substrate cleaning solution formed of a citric acid aqueous solution, into which a chelating agent is added, in order to remove a metal or metallic compound on a substrate, and also a semiconductor device manufacturing method which employs a citric acid aqueous solution, into which the chelating agent is added, as the cleaning solution in a substrate cleaning step after the CMP step, in order to achieve high yield. The chelating agent reacts with metallic complex which is formed by a reaction between the citric acid and the metal, then extracts metallic ions from the metal complex, and then reacts with the metallic ions to form chelating compound. Thus, the citric acid can be reused by action of the chelating agent. As a result, the citric acid aqueous solution of a low concentration can achieve an effect of removing metal or metallic oxide, which is equivalent to or more than the citric acid aqueous solution of a high concentration.

### BACKGROUND OF THE INVENTION

1. Field of the Invention

The present invention relates to cleaning of a semiconductor substrate carried out in steps of manufacturing semiconductor devices. More particularly, the present invention relates to a substrate cleaning solution for use in removal of metal residues on a surface of the semiconductor substrate, and a semiconductor device manufacturing method for executing the substrate cleaning by using the substrate cleaning solution after the CMP step.

2. Description of the Related Art

In recent years, planarization is effected by using the CMP (Chemical Mechanical Polishing) method in many steps of manufacturing the semiconductor device. For example, in case a tungsten (W) film employed as wirings is planarized by using the CMP method, a substrate surface is polished mechanically while using alumina particles acting as abrasive grains, and concurrently the substrate surface is also polished chemically while using acidic etchant containing iron ions, etc. acting as the abrasive liquid.

Various metals or metallic compounds such as iron (Fe) ion contained in the etchant and etched tungsten (W), or the alumina (Al₂O₃) acting as the abrasive grains are adhered onto the substrate surface immediately after the CMP step. Therefore, the substrate must be cleaned to remove such various metals or metallic compounds.

However, these various metals or metallic oxides cannot be sufficiently removed according to the normal cleaning method which employs only the pure water. If the metals or metallic oxides remain on the substrate surface, they have various harmful effects on electrical parameters of the semiconductor device to thus reduce yield.

Accordingly, in the prior art, in the substrate cleaning step to be carried out after the CMP step, normally the citric acid (C₆H₈O₇) aqueous solution which has been known to have the high metal ion removing effect is employed as the cleaning solution. However, in order to complete the cleaning step within an allowable time in practical use, citric acid aqueous solution of a considerably high concentration must be employed because a rate of metal removing reaction of the citric acid is slow. As a result, in the prior art, the aqueous solution of the citric acid concentration of 30 vol % or more has been employed as the cleaning solution. Since a great deal of cleaning solution must be used to clean the substrate, a material cost required for a necessary amount of the citric acid has become enormous.

In addition, even if the citric acid aqueous solution of such high concentration is employed as the cleaning solution, an effect of removing adhered matters including the metals is not always satisfactory in the existing state. As a consequence, defects in parameters of the device, which may be supposed to be caused by residual metals, have often occurred.

### SUMMARY OF THE INVENTION

It is an object of the present invention to provide a cleaning solution which is able to achieve a high metal or metallic compound removing effect and to bring the cost down.

It is another object of the present invention to provide a semiconductor device manufacturing method which is able to provide a high yield in the semiconductor device manufacturing method by using the CMP step.

In order to achieve the above object of the present invention, according to an aspect of the present invention, there is provided a cleaning solution comprising a chelating agent which is added into an aqueous solution containing a citric acid.

According to the aspect of the present invention, a high metal removing effect can be achieved because of the synergetic effect between the citric acid and the chelating agent. Hence, the metal or metallic compound removing effect which is equivalent to or more than that of the cleaning solution in the prior art can be performed by the cleaning solution in which a small amount of the chelating agent is added into the citric acid aqueous solution of a low concentration. Since a necessary amount of the citric acid can be reduced, a material cost of the cleaning solution can be brought down.

If the above chelating agent belongs to any one of a phosphonic acid, a phosphoric acid, and a carboxylic acid, the above synergetic effect can be achieved effectively.

In particular, if the above chelating agent belongs to any one of an ethilidenediphosphonic acid, a methylphosphonic acid, and a methyldiphosphonic acid, the above synergetic effect can be achieved remarkably.

In this case, in the event that the above chelating agent belongs to any one of the ethilidenediphosphonic acid, the methylphosphonic acid, and the methyldiphosphonic acid, the cleaning solution in which the chelating agent is added by 10 ppm or more into the citric acid aqueous solution of a citric acid concentration of more than 1 vol % can realize the cleaning effect being at least equivalent to that of the cleaning solution in the prior art, while suppressing the citric add concentration at an about 1/10 level relative to the cleaning solution in the prior art.

Especially, the cleaning solution in which the chelating agent is added by 30±3 ppm into the citric acid aqueous solution of a citric acid concentration of 3±0.3 vol % can perform the metal or metallic compound removing effect which exceeds that of the cleaning solution in the prior art.

In order to achieve the another object of the present invention, according to another aspect of the present invention, there is provided a semiconductor device manufacturing method, comprising the step of employing a solution, in which a chelating agent is added into an aqueous solution containing a citric acid, as a cleaning solution in a substrate cleaning step executed after a CMP step.

Since, in the CMP step, normally the surface of the substrate is mechanically polished by use of an abrasive liquid containing metal ions and abrasive grains such as metal oxide, etc., a plenty of such metal or metallic compound remain on the surface of the substrate after the CMP step. Thus, the solution which is formed by adding the chelating agent into the aqueous solution containing the citric acid can perform a high metal removing effect owing to the synergetic effect between the citric acid and the chelating agent. Therefore, if the substrate cleaning is carried out by using such cleaning solution after the CMP step, the metal adhesive on the surface of the substrate can be removed effectively to provide a clean surface of the substrate. For this reason, defects due to residual metal after the cleaning can be suppressed and thus yield of the products can be improved.

Because of the synergetic effect between the citric acid and the chelating agent, the metal or metallic compound removing effect being equivalent to or more than the conventional cleaning solution can be achieved by the cleaning solution in which a small amount of chelating agent is added into the citric acid aqueous solution of a low concentration. Therefore, a necessary amount of the citric acid can be reduced and a cleaning process cost can be lowered.

Particularly, in the substrate cleaning step executed after the CMP step to form the Cu wiring, if the solution in which the chelating agent is added into the aqueous solution containing the citric acid is employed as the cleaning solution, not only the abrasive liquid and the abrasive grains employed in the CMP process, but also the copper oxide layer formed on the surface of the Cu wiring can be reduced effectively. As a result, the Cu wiring having good electric characteristics can be formed.

### BRIEF DESCRIPTION OF THE DRAWINGS

FIG. 1 is a table showing data of a metal removing effect in case a substrate is cleaned by a cleaning solution according to an embodiment of the present invention; and

FIG. 2 is a view showing an example of a reaction caused between the cleaning solution and residual metal in case the substrate is cleaned by using the cleaning solution according to the embodiment of the present invention.

### DESCRIPTION OF THE PREFERRED EMBODIMENTS

A cleaning solution and a cleaning method by using the cleaning solution according to embodiments of the present invention will be explained with reference to the accompanying drawings hereinafter.

A feature of the cleaning solution according to an embodiment of the present invention is that a very small amount of chelating agent is added into a citric acid aqueous solution of a low concentration. For instance, this cleaning solution can be prepared by adding a phosphonic acid chelating agent by about 30 ppm into the citric acid aqueous solution which has 1/10 the concentration of the conventional citric acid aqueous solution employed in the substrate cleaning after the CMP(Chemical Mechanical Polishing)step in the prior art.

Actually a cleaning operation of the substrate sample has been carried out by using the cleaning solution according to the embodiment, and then a metal removing effect of the cleaning solution according to the embodiment has been compared with that of the cleaning solution, etc. in the prior art. Then, results of examinations conducted by the inventors of the present invention will be explained hereinbelow.

### I. EXAMPLE

To begin with, in this examination, the substrate cleaning carried out after the CMP step is assumed, and then pretreatment of the substrate sample serving as to-be-cleaned material has been carried out previously before the substrate cleaning under conditions which correspond to those in the normal CMP step.

A silicon (Si) substrate, on a surface of which a silicon oxide (SiO₂) film is formed, has been utilized as the substrate sample. With the use of alumina (Al₂O₃) particles as abrasive grains and also an iron nitrate solution as an abrasive liquid, a surface of the substrate sample is polished mechanically for about 60 seconds and concurrently the surface of the substrate sample is also etched chemically.

Three types of cleaning solutions including the cleaning solution according to the embodiment have been prepared in the following. More particularly, 1) the cleaning solution made of only the pure water, 2) the cleaning solution employed in the prior art, and 3) the cleaning solution according to the embodiment of the present invention. Where the cleaning solution employed in the prior art in 2) is the citric acid aqueous solution of a concentration of 30±3 vol %, and the cleaning solution according to the embodiment in 3) is a cleaning solution in which the chelating agent is added by about 30±3 ppm into the citric acid aqueous solution of a concentration of about 30±0.3 vol %.

In this case, a 1-hydroxyethilidene-1 and an 1-diphosphonic acid (C₂H₈O₇P₂), which is one of the phosphonic acid chelating agent, are employed as the chelating agent.

Three sheets of substrate samples which have been subjected to pretreatment have been prepared. Each substrate has been cleaned one by one by using any of above three types of cleaning solutions. As the cleaning method, a way in which a predetermined cleaning solution is dropped onto the substrate surface at a flow rate of 500 ml/min for 30 seconds has been employed.

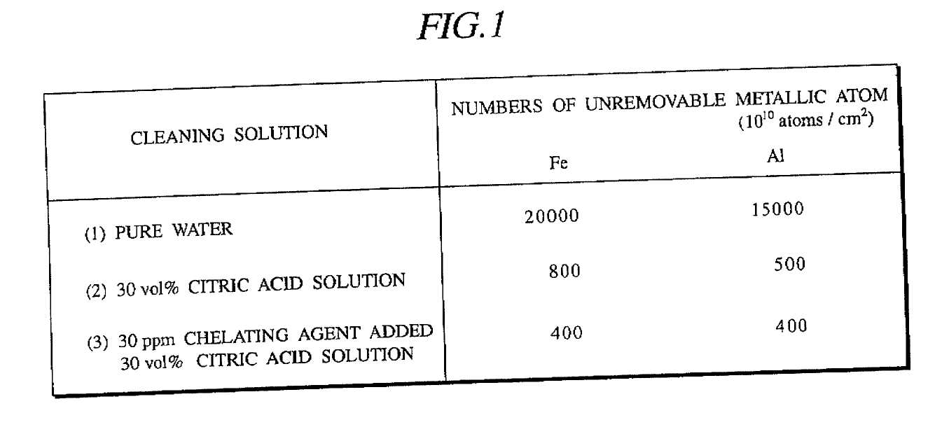

Numbers of iron (Fe) and aluminum (Al) atoms, both remain on the surfaces of the substrate samples respectively, have been measured by use of the VPD (Vapor Phase Detector) method after the substrate cleaning. Results of this measurement are shown in FIG. 1.

In case only the pure water in 1) is employed as the cleaning solution, a great deal of residual metals such as Fe atoms of 2 0×10¹⁴ atoms/cm² and Al atoms of 1.5×10¹⁴ atoms/cm² have been detected from the surface of the substrate sample after the substrate cleaning.

In contrast, in case the citric acid aqueous solution of the concentration of 30 vol %, which is the cleaning solution employed in the prior art in 2), is employed as the cleaning solution, Fe atoms of 8×10¹⁴ atoms/cm² and Al atoms of 5×10¹² atoms/cm² have been detected from the surface of the substrate sample after the substrate cleaning. The numbers of unremovable metallic atoms have been reduced considerably rather than the case where only the pure water is employed as the cleaning solution. Namely, it has been understood that iron nitrate employed as the abrasive liquid and alumina employed as the abrasive grains can be removed effectively by the citric acid aqueous solution.

However, in case the cleaning solution in which the phosphonic acid chelating agent is added into the citric acid aqueous solution according to the present embodiment is employed, merely Fe atoms of 4×10¹² atoms/cm² and Al atoms of 4×10¹² atoms/cm² have been able to be detected from the surface of the substrate sample after the substrate cleaning. As a result, an amount of residual metal has been reduced still farther.

Like the above, based on the above results of examination, it has been confirmed that, although the concentration of the citric acid in the cleaning solution according to the embodiment of the present invention is reduced merely to 1/10 in the cleaning solution in the prior art, the high metal removing effect can be achieved by using the iron nitrate as the abrasive liquid and the alumina as the abrasive grains in the CMP step rather than the cleaning solution in the prior art.

In the meanwhile, even if the aqueous solution containing only the phosphonic acid chelating agent used herein is employed as the cleaning solution, the effect of removing the metal or metallic compound is extremely low rather than the cleaning solution which is formed of the citric acid aqueous solution. That is to say, it may be guessed that the phosphonic add chelating agent is difficult to react directly with the metal or metallic compound. Therefore, it may be considered that the high metal removing effect which can be obtained by adding the phosphonic acid chelating agent into the citric acid aqueous solution is not an effect which can be achieved by simply adding two types of cleaning agents both having the metal removing effect, but a synergetic effect which can be achieved by composite reaction among the citric acid, the chelating agent, and the metal.

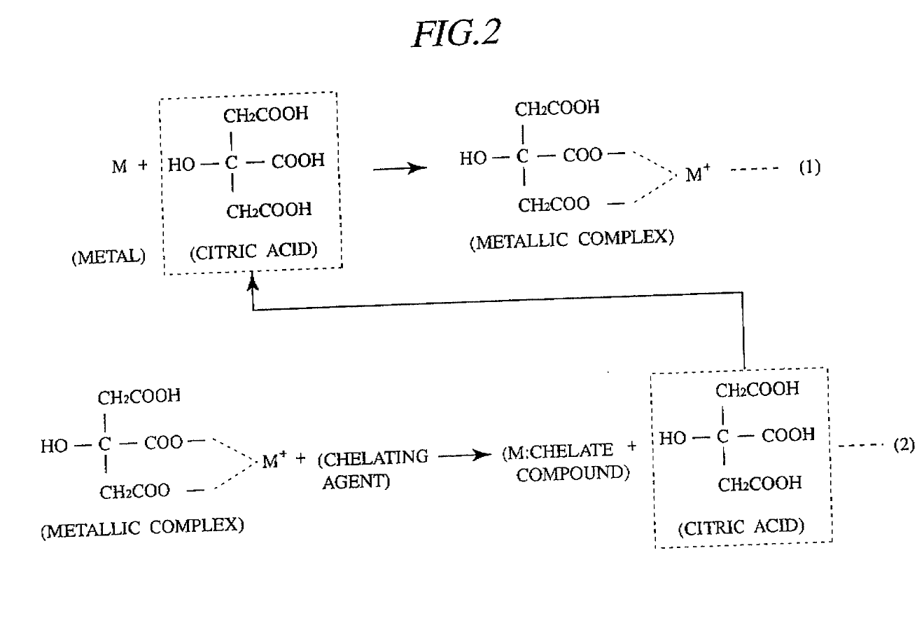

FIG. 2 shows an example of a composite reaction caused among the citric acid, the chelating agent, and the metal, which is anticipated by the inventors of the present invention. More particularly, as indicated by a chemical formula (1) shown in FIG. 2, it may be thought of that, if the substrate is cleaned by using the cleaning solution in which the chelating agent is added into the citric acid aqueous solution, first the metal being adhered onto the substrate or the metal being contained in the metallic compound can react preferentially with the citric acid to thus form the metal complex. For example, the iron and the citric acid contained in the residual abrasive liquid reacts with each other to thus form the metal complex such as ferric citrate (FeC₆H₅O₇), etc.

As indicated by a chemical formula 2) in FIG. 2, it may be considered that the phosphonic acid chelating agent being added can react with the metallic complex. Such metallic complex is formed by the reaction between the citric acid and the metal on the surface of the substrate. More particularly, the chelating agent can extract the metallic ions from the metallic complex and then react with extracted metallic ions to thus form a chelating compound, whereas the metallic complex from which the metallic ions have been extracted is restored into the citric acid. In this manner, the citric acid reproduced as above can repeat the metal removing reaction indicated by the chemical formula (1) again and again.

According to this consideration, it is possible to say that addition of the phosphonic acid chelating agent has such an effect that the metal removing function of the citric acid can be changed into a reusable function. As a result, it may be supposed that, since the metal removing function of the citric acid can be performed repeatedly, an effect which is comparable to that obtained when a large amount of citric acid is used can be achieved by using a small amount of citric acid.

In the above examination, the citric acid aqueous solution of the concentration of 3±0.3 vol %, into which the chelating agent is added by 30±3 ppm, has been employed as the cleaning solution. But, based on the experience of the inventors of the present invention, if the citric acid concentration is reduced while keeping an addition amount as it is, the cleaning ability of the cleaning solution has been degraded correspondingly. On the contrary, even if the citric acid concentration is enhanced to exceed the above, the cleaning ability of the cleaning solution has been saturated.

As for the citric acid concentration of 3±0.3 vol %, the highest cleaning effect has been detected when an addition amount of the chelating agent is set to 30±3 ppm. As for the citric acid concentration of 1±0.1 vol %, the highest cleaning effect has been detected when an addition amount of the chelating agent is set to 10±1 ppm. In this manner, the good cleaning effect can be attained if a ratio of the concentration of the citric acid aqueous solution to an addition amount of the chelating agent is fitted for the above ratio. In the case of the citric acid concentration of 1±0.1 vol %, the cleaning effect which is substantially same as the cleaning solution in the prior art has been attained.

### II. EXAMPLE OF CLEANING AFTER CMP STEP IN FORMATION OF W WIRING

In the above examination, the silicon substrate, on a surface of which an SiO₂ film is formed and which is subjected the CMP process has been cleaned. However, in the normal semiconductor manufacturing step, mainly the CMP process has been widely employed as a means for planarizing the surface of the substrate in the wiring forming step.

In the substrate cleaning step after the CMP process to form the W wiring in the semiconductor device manufacturing step, a method of cleaning the substrate by using the cleaning solution according to the embodiment will be explained hereinbelow.

Memories, CMOS devices, or the Like, which consist of a gate oxide film, a gate electrode, and various diffusion regions, are formed on the semiconductor substrate. Then, an interlayer insulating film made of an SiO₂ film, etc. is formed on the surface of the substrate. Then, contact holes are formed in the interlayer insulating film to extend electrodes from various diffusion regions. Then, a thin film of W is formed by using the sputter method, etc. so as to bury respective contact holes. The surface of the substrate is covered with the W layer which has undulations reflecting profiles of the contact holes and the underlying patterns.

Then, the surface of the substrate is planarized by polishing the surface of the substrate by using the CMP step until the interlayer insulating film is exposed, and simultaneously a buried wiring layer is formed. For instance, while employing the alumina particles having an average diameter of less than 0.35 μm as the abrasive grams and employing the iron nitrate aqueous solution of a concentration of 7.9 wt % as the abrasive liquid, the CMP process is carried out for about 120 seconds to scrape off convex portions of the W film by about 0.5 μm, so that the surface of the substrate can be planarized.

After CMP process, the substrate is cleaning with the cleaning solution according to the above embodiment. The cleaning solution is prepared by adding the 1-hydroxyethilidene-1 and the 1-diphosphonic acid (C₂H₈O₇P₂) of about 30±3 ppm as the chelating agent into the citric acid aqueous solution of a concentration of 3±0.3 vol %. In this cleaning process, the cleaning solution is dropped onto the surface of the substrate for about 30 seconds at a flow rate of 500 ml/min. While dropping the cleaning solution, the substrate is being rotated to spread it over the surface well. Then, the substrate is rinsed with a pure water.

In this way, the compound containing the iron nitrate used as the abrasive liquid and the metal such as alumina, etc. used as the abrasive grains as well as the metal of the polished material such as W can be removed more effectively than the prior art. Especially, like Fe having a high ionization rate, the metal which has a tendency to form the metallic complex with the citric acid can be removed more effectively.

### III. EXAMPLE OF CLEANING AFTER CMP STEP IN FORMATION OF Cu WIRING

The cleaning solution according to the embodiment described above can be employed in cleaning after the CMP step, which is carried out in the step of forming the Cu wiring the development of which is promoted recently. The CMP process to be applied to Cu can also be performed with the substantially same procedures as those in the above CMP process to be applied to W. In this case, such a problem has been pointed out that, since the Cu wiring is oxidized extremely readily rather than the normal wiring material, a copper oxide layer is left on a surface of the wiring immediately after the CMP step. It is desired that such copper oxide layer should be removed since it causes degradation of electric characteristics of the copper wiring.

By using the cleaning solution according to the present embodiment in which the 1-hydroxyethilidene-1 and the 1-diphosphonic acid (C₂H₈O₇P₂) are added by 30±3 ppm into the citric acid aqueous solution of the concentration of 3±0.3 vol %, the inventors of the present invention have conducted the substrate cleaning after the CMP step of the Ca wiring. At that time, it has been able to be confirmed that only the copper oxide on the surface can be removed without removal of Cu per se.

According to this fact, it has been found that, if the cleaning solution according to the embodiment is employed in cleaning after the CMP step to form the Cu wiring, not only reduction in process cost but also formation of the Cu wiring having good electric parameters can be effectively carried out.

As described above, even if the citric acid concentration is reduced to 1/10 relative to the cleaning solution in the prior art, the cleaning solution according to the embodiment can achieve the higher effect of removing the metal or metallic compound than that of the conventional cleaning solution by adding a very small amount of chelating agent. Because of this higher removing effect, the number of electrical defects due to residual metal can be reduced to thus improve yield of the device.

According to the cleaning solution in the present embodiment, because only a small amount of the citric acid is needed, the material cost of the cleaning solution as well as the process cost of the cleaning step can be significantly reduced.

In the present embodiment, the 1-hydroxyethilidene-1 and the 1-diphosphonic acid (C₂H₈O₇P₂) are employed as the chelating agent, but similar effects can be attained by using other phosphonic acid chelating agents. For example, an ethilidenediphosphonic acid, a methylphosphonic acid, a methyldiphosphonic acid, or the like may be employed in addition to the above An aminotrimethylphosphonic acid (C₂H₁₂O₉P₃N), etc. may be listed as examples of the methylphosphonic acid.

Other chelating agents can be employed regardless of the above phosphonic acid elating agent as the above chelating agents can react selectively with the metal in the metallic complex, which is formed by the citric acid and the metallic ion, to thus form a new chelating compound. For instance, the similar effect can be expected by using the phosphoric acid or carboxylic acid chelating agent.

In addition, it is possible to employ an acidic solution such as a tartaric acid, etc., which can be bonded with the metallic ions to thus form the metal complex, as an alternative solution for the citric acid.

In the above embodiment, there has been described the substrate cleaning which is carried out after the CMP process of the W film formed on the substrate surface has been effected. Nevertheless, objects to be polished by the CMP process are not limited to the W layer and the Cu layer, other wiring material may be employed. Furthermore, a semiconductor such as polysilicon, silicon substrate, etc. and an insulating film such as an SiO₂ film, an SiNx film, etc. are formed on the surface of the substrate. In case either the surface is polished mechanically by using the abrasive grains made of metallic compound or the surface is etched by the etchant containing metallic ions, etc. in the CMP process of these surfaces, the metallic ions, etc. remain on the surface of the substrate after the etching. Therefore, the cleaning solution according to the present embodiment is effective to remove the metal if the surface is cleaned by using the above cleaning solution according to the present embodiment.

The cleaning solution according to the present embodiment can be utilized in all cleaning steps applied to remove the metal residue, in addition to the semiconductor substrate cleaning after the CMP process.

With the above, although the explanation has been made along the embodiments, the present invention is not limited to these embodiments. For instance, it is evident for the person skilled in the art that various variations, improvements, combinations, etc. of the present embodiment may be easily applied.

What is claimed is:

1. A cleaning solution comprising:
a chelating agent which is added into an aqueous solution containing a citric acid.

2. A cleaning solution according to claim 1, wherein the chelating agent belongs to any one of a phosphonic acid, a phosphoric acid, and a carboxylic acid.

3. A cleaning solution according to claim 1, wherein the chelating agent belongs to any one of an ethilidenediphosphonic acid, a methylphosphonic acid, and a methyldiphosphonic acid.

4. A cleaning solution according to claim 3, wherein the aqueous solution containing the citric acid is an aqueous solution of a citric acid concentration of more than 1 vol %, and
the chelating agent is added into the aqueous solution containing the citric acid by 10 ppm or more.

5. A cleaning solution according to claim 4, wherein the aqueous solution containing the citric acid is an aqueous solution of a citric acid concentration of 3±0.3 vol %, and
the chelating agent is added into the aqueous solution containing the citric acid by 30±3 ppm.

6. A semiconductor device manufacturing method, comprising the step of:
forming a film on a substrate;
chemical mechanical polishing a surface of the substrate;
cleaning the substrate after the CMP step;
wherein the cleaning is executed by using a cleaning solution comprising a chelating agent added aqueous solution containing a citric acid.

7. A semiconductor device manufacturing method according to clam 6, wherein a chelating agent which belongs to any one of a phosphonic acid, a phosphoric acid, and a carboxylic acid is employed as the chelating agent.

8. A semiconductor device manufacturing method according to claim 6, wherein a chelating agent which belongs to any one of an ethilidenediphosphonic acid, a methylphosphonic acid, and a methyldiphosphonic acid is employed as the chelating agent.

9. A semiconductor device manufacturing method according to claim 8, wherein the aqueous solution containing the citric acid is an aqueous solution of a citric acid concentration of more than 1 vol %, and
the chelating agent is added into the aqueous solution containing the citric acid by 10 ppm or more.

10. A semiconductor device manufacturing method according to claim 8, wherein an ethilidenediphosphonic acid is employed as the chelating agent,
the aqueous solution containing the citric acid is an aqueous solution of a citric acid concentration of 3±0.3 vol %, and
the chelating agent is added into the aqueous solution containing the citric acid by 30±3 ppm.

11. A semiconductor device manufacturing method, comprising the step of:
forming a Cu film on a substrate;
chemical mechanical polishing a surface of the substrate to form Cu wiring;
cleaning the substrate after the CMP step;
wherein the cleaning is executed by using a cleaning solution comprising a chelating agent added aqueous solution containing a citric acid.

12. A semiconductor device manufacturing method according to claim 11 wherein a chelating agent which belongs to any one of an ethilidenediphosphonic acid, a methylphosphonic acid, and a methyldiphosphonic acid is employed as the chelating agent.

13. A semiconductor device manufacturing method according to claim 12, wherein the aqueous solution containing the citric acid is an aqueous solution of a citric acid concentration of more than 1 vol %, and
the chelating agent is added into the aqueous solution containing the citric acid by 10 ppm or more.

14. A semiconductor device manufacturing method according to claim 11, wherein an ethilidenediphosphonic acid is employed as the chelating agent,
the aqueous solution containing the citric acid is an aqueous solution of a citric acid concentration of 3±0.3 vol %, and
the chelating agent is added into the aqueous solution containing the citric acid by 30±3 ppm.
